(19) United States
(12) Patent Application Publication
(10) Pub. No.: US 2025/0299307 A1
(43) Pub. Date: Sep. 25, 2025

(54) IMAGE MEASURING APPARATUS AND PROGRAM

(71) Applicant: MITUTOYO CORPORATION, Kawasaki (JP)

(72) Inventors: Yoshiaki Kato, Saitama (JP); Miyako Mizutani, Kanagawa (JP); Jota Miyakura, Chiba (JP)

(21) Appl. No.: 19/083,053

(22) Filed: Mar. 18, 2025

(30) Foreign Application Priority Data
Mar. 25, 2024 (JP) 2024-048478

(51) Int. Cl. G06T 5/80; G06T 5/50; G06T 7/00; G06T 7/586; G06T 7/80

(52) U.S. Cl. CPC G06T 5/80; G06T 5/50; G06T 7/0006; G06T 7/001; G06T 7/586; G06T 7/80; G06T 2207/30164

(57) ABSTRACT

An image measuring apparatus that can flexibly perform distortion correction in response to environmental changes is provided. The image measuring apparatus according to the present invention comprises: a stage on which a measurement target is placed; a reference pattern display unit on which a reference pattern is displayed; an image capturing unit that captures images of a subject; a distortion information generation unit that generates distortion information based on an image of the reference pattern captured by the image capturing unit and design information of the reference pattern; and a correction unit that corrects an image of the measurement target captured by the image capturing unit using the distortion information.

### CROSS-REFERENCE TO RELATED APPLICATION

This non-provisional application claims priority under 35 U.S.C. § 119(a) from Japanese Patent Application No. 2024-048478, filed on Mar. 25, 2024, the entire contents of which are incorporated herein by reference.

### BACKGROUND OF THE INVENTION

### Field of the Invention

The present invention relates to an image measuring apparatus that measures the shape of a measurement target without contact based on an image obtained by capturing the measurement target, and a program.

### Description of the Related Art

An image measuring apparatus is an apparatus that captures an image of a measurement target (hereinafter referred to as “workpiece”), analyzes the image, extracts a shape such as line, circle, and polygon or the like, and obtains a measurement result such as distance, inclination, diameter, width or the like of the extracted shapes.

When the image is captured with a camera, if the captured image is distorted due to lens distortion or other factors, this distortion will directly lead to a deterioration in measurement accuracy. For this reason, high-precision optical design is required, but it is difficult to avoid residual distortion in the captured image due to factors such as the tolerance of lens machining.

As a technique for dealing with such problems, there is a known camera calibration technique that corrects the distortion remaining in the image based on the distortion information obtained by comparing the image captured by the camera with the design value of the reference pattern. Conventional image measuring apparatus often has a function to correct image distortion using such camera calibration techniques (see, for example, Japanese Patent Publication No. 2005-4391).

### SUMMARY OF THE INVENTION

### Problems to be Solved by the Invention

The shape of the camera lens and light-receiving element of the image measuring apparatus is easily affected by environmental changes such as temperature. Therefore, if the temperature changes after the distortion information is obtained, or if the image measuring apparatus is moved from the location where the distortion information was obtained, questions may arise about the accuracy of the distortion information. To ensure the accuracy of the correction, it is therefore preferable to obtain the distortion information again. However, in order to obtain distortion information and perform correction at the time of measurement, it was necessary to place a plate with a reference pattern engraved on it on the stage, capture an image of the plate, replace the plate with the measurement target, capture an image of the measurement target, and then perform the necessary operations to obtain the distortion information. This was a time-consuming process, and it was difficult to perform flexible distortion correction in response to environmental changes.

An objective of the present invention is to provide an image measuring apparatus that can flexibly perform distortion correction in response to environmental changes and a program.

### Means for Solving the Problems

An image measuring apparatus according to one aspect of the present invention comprises: a stage on which a measurement target is placed; a reference pattern display unit on which a reference pattern is displayed; an image capturing unit that captures images of a subject; a distortion information generation unit that generates distortion information based on an image of the reference pattern captured by the image capturing unit and design information of the reference pattern; and a correction unit that corrects an image of the measurement target captured by the image capturing unit using the distortion information.

### Effects of the Invention

According to the image measuring apparatus of the present invention, since the reference pattern is built in, even when distortion information is acquired and correction is performed during measurement, there is no need to replace the reference pattern on the stage with the measurement target. This reduces the effort required to acquire distortion information, and therefore makes it possible to perform distortion correction flexibly in response to environmental changes.

### BRIEF DESCRIPTION OF THE DRAWINGS

FIG. 1 shows the functional block diagram of the image measuring apparatus 100 according to the present invention.

FIG. 2 shows the functional block diagram of the image measuring apparatus 101 according to the present invention.

FIG. 3 shows the functional block diagram of the image measuring apparatus 102 according to the present invention.

FIG. 4 shows the functional block diagram of the image measuring apparatus 103 according to the present invention.

### DETAILED DESCRIPTION OF THE EMBODIMENTS

### First Embodiment

Embodiments of the present invention will be described below with reference to the drawings. In the following description, portions already described are denoted by the same reference numerals, and description thereof is omitted.

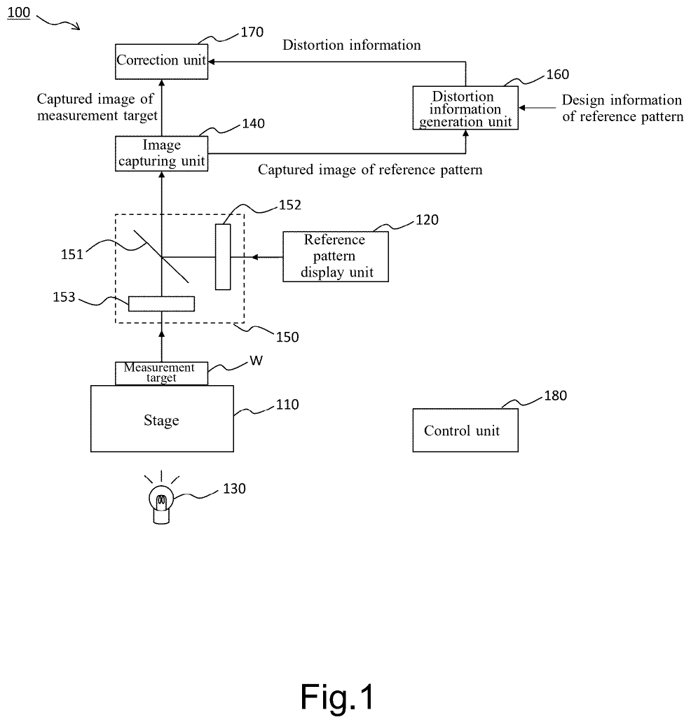

FIG. 1 shows the functional block diagram of the image measuring apparatus 100 according to the first embodiment. The image measuring apparatus 100 includes a stage 110, a reference pattern display unit 120, a light source 130, an image capturing unit 140, a subject switching unit 150, a distortion information generation unit 160, a correction unit 170, and a control unit 180.

The stage 110 is arranged so that its upper surface (mounting surface) is horizontal. A measurement target W is placed on the mounting surface. The stage 110 has a driving means for horizontal direction such as motors and actuators, and two-dimensional movement is achieved under the control of the control unit 180.

A reference pattern is displayed on the reference pattern display unit 120. The display of the reference pattern is done by engraving or depositing the reference pattern on the surface of a substrate, such as plate glass.

The light source 130 is a light-emitting means that irradiates light on the subject at a brightness and position that is sufficient for image measurement and distortion correction when the image capturing unit 140 captures an image of the subject. If natural light is sufficient to illuminate the subject, it is not necessary to provide the light source 130.

The image capturing unit 140 is an imaging means for capturing images of the measurement target and the reference pattern, which are the subject of the image. The captured image may be temporarily or permanently stored in any type of storage medium.

For example, a subject switching unit 150 may be provided to switch which subject is captured by the image capturing unit 140 when capturing each of the measurement target and the reference pattern.

The subject switching unit 150 may, for example, include a beam splitter 151 that emits incident light from the reference pattern display unit 120 and incident light from the measurement target W toward the image capturing unit 140, a shutter 152 provided between the reference pattern display unit 120 and the beam splitter 151, and a shutter 153 provided between the measurement target W and the beam splitter 151. In this configuration, for example, when the image capturing unit 140 captures the reference pattern, the shutter 152 is opened and the shutter 153 is closed, and when the measurement target W is captured, the shutter 152 is closed and the shutter 153 is opened.

The distortion information generation unit 160 generates distortion information based on the image of the reference pattern captured by the image capturing unit 140 and the design information of the reference pattern that has been prepared in advance. Specifically, the dimensions of the reference pattern read from the captured image are compared with the design dimensions and dimensional tolerances, and distortion information is generated based on the difference between them.

The correction unit 170 corrects the image of the measurement target W captured by the image capturing unit 140 using the distortion information generated by the distortion information generation unit 160.

The control unit 180 performs control based on information input by the operator or based on a program that describes the processing flow and functions of each functional unit. The control unit 180 may be implemented by a personal computer that, for example, includes a CPU that executes a program to realize the described functions, various storage means that temporarily or permanently store programs and data, various input means such as keyboards and mice, various display means, and various communication means such as wired or wireless communication means.

Under the control of control unit 180, the correction process in the first embodiment is performed, for example, as follows.

When the operator places the measurement target W on stage 110 and issues a command to the control unit 180, the control unit 180 executes the correction process by controlling each functional unit according to the processing flow described in the program. Specifically, first, the shutter 152 is opened and the shutter 153 is closed, and then the image capturing unit 140 is caused to capture an image to acquire an image of the reference pattern. In addition, the shutter 152 is closed and the shutter 153 is opened, and then the image capturing unit 140 is caused to capture an image to acquire an image of the measurement target W. At this time, each captured image may be stored in a suitable storage means. Next, the distortion information generation unit 160 is caused to generate the distortion information based on the image of the reference pattern and the design information of the reference pattern that has been prepared in advance. Then, the correction unit 170 is caused to correct the image of the measurement target W using the distortion information generated by the distortion information generation unit 160. The image of the measurement target W that has been corrected in this way is then used in the image measurement process.

According to the image measuring apparatus 100 of the present invention described above, since the reference pattern is built in, there is no need to place the reference pattern on the stage when acquiring distortion information. Therefore, when acquiring distortion information during measurement, there is no need to replace the reference pattern on the stage with the measurement target. Therefore, the reference pattern can be automatically captured and distortion information can be generated at any arbitrary timing, for example, immediately before or during the execution of image measurement. As a result, the effort required to obtain distortion information is reduced, and it is possible to perform distortion correction flexibly in response to environmental changes.

Moreover, since the images of the reference pattern and the measurement target are acquired separately, it is possible to perform image measurement with the same quality as that of conventional methods.

In addition, since the light path from the reference pattern is combined with the light path from the stage to the image capturing unit using the beam splitter, it is possible to retrofit this system to an existing apparatus.

### Second Embodiment

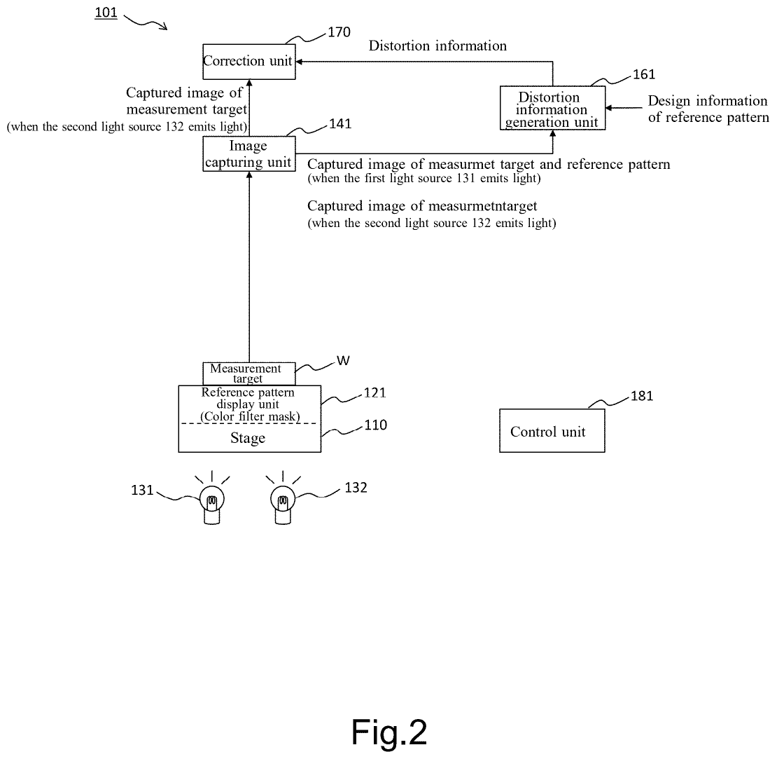

FIG. 2 shows the functional block diagram of the image measuring apparatus 101 according to the second embodiment. The image measuring apparatus 101 includes a stage 110, a reference pattern display unit 121, a first light source 131, a second light source 132, an image capturing unit 141, a distortion information generation unit 161, a correction unit 170, and a control unit 181.

On the mounting surface of the stage 110, a reference pattern is formed with a color filter mask that selectively transmits light in a predetermined wavelength range. The color filter mask serves as the reference pattern display 121. The reference pattern using the color filter mask may be formed by directly depositing it on the mounting surface of the stage 110, or it may be formed by depositing it on a surface of a substrate such as glass and then placing the substrate on the mounting surface of the stage 110.

In this way, the stage 110 and the reference pattern display unit 121 are configured as a single unit, and the measurement target W is placed on the reference pattern.

The first light source 131 is a light-emitting means that emits light of wavelengths that do not transmit through the color filter mask.

The second light source 132 is a light-emitting means that emits light of wavelengths that transmit through the color filter mask.

The first light source 131 and second light source 132 irradiate light on the subject at a brightness and position that is sufficient for image measurement and distortion correction when the image capturing unit 141 captures an image of the subject.

The image capturing unit 141 is directed towards the stage 110 (reference pattern display unit 121) in order to capture images of the measurement target W and the reference pattern formed by the color filter mask. Since the color filter mask has wavelength selectivity, there is a difference in the captured image depending on whether the image is captured when only the first light source 131 emits light or when only the second light source 132 emits light. Specifically, when only the first light source 131 emits light, the emitted light does not transmit through the color filter mask, so an image containing the reference pattern formed by the color filter mask and the measurement target W is obtained. If the image is captured when only the second light source 132 emits light, the emitted light transmits through the color filter mask, so an image containing the measurement target W but not the reference pattern is obtained.

The distortion information generation unit 161 generates distortion information based on the image containing the measurement target W and the reference pattern and the image containing the measurement target W but lacking the reference pattern, both of which are captured by the image capturing unit 141, and the design information of the reference pattern prepared in advance. Specifically, first, by subtracting the image containing the measurement target W but lacking the reference pattern from the image containing the measurement target W together with the reference pattern, an image containing only the reference pattern is generated. Then, the dimensions of the reference pattern read from the image of the reference pattern obtained in this way are compared with the design dimensions and dimensional tolerances, and distortion information is generated based on the difference between the them.

The correction unit 170 outputs an image for image measurement by correcting the image containing the measurement target W but lacking the reference pattern captured by the image capturing unit 141 using the distortion information generated by the distortion information generation unit 160.

The control unit 181 performs control based on information input by the operator or based on a program that describes the processing flow and functions of each functional unit. The control unit 181 may be implemented by a personal computer that, for example, includes a CPU that executes a program to realize the described functions, various storage means that temporarily or permanently store programs and data, various input means such as keyboards and mice, various display means, and various communication means such as wired or wireless communication means.

Under the control of control unit 181, the correction process in the second embodiment is performed, for example, as follows.

When the operator places the measurement target W on stage 110 and issues a command to the control unit 181, the control unit 181 executes the correction process by controlling each functional unit according to the processing flow described in the program. Specifically, first, by causing only the first light source 131 to emit light, the image capturing unit 141 is caused to capture an image of the reference pattern together with the measurement target W. Further, by causing only the second light source 132 to emit light, the image capturing unit 141 is caused to capture an image containing the measurement target W but lacking the reference pattern. At this time, each captured image may be stored in a suitable storage means. Next, the distortion information generation unit 161 is caused to generate the image of the reference pattern from the image containing the measurement target W and the reference pattern and the image containing the measurement target W but lacking the reference pattern, and to generate distortion information based on this image of the reference pattern and the design information of the reference pattern prepared in advance. Then, the correction unit 170 is caused to correct the image containing the measurement target W but lacking the reference pattern using the distortion information generated by the distortion information generation unit 161. The image that has been corrected in this way is then used in the image measurement process.

According to the image measuring apparatus 101 of the present invention described above, since the reference pattern is built in, there is no need to place the reference pattern on the stage when acquiring distortion information. Therefore, when acquiring distortion information during measurement, there is no need to replace the reference pattern on the stage with the measurement target. Therefore, the reference pattern can be automatically captured and distortion information can be generated at any arbitrary timing, for example, immediately before or during the execution of image measurement. As a result, the effort required to obtain distortion information is reduced, and it is possible to perform distortion correction flexibly in response to environmental changes.

Moreover, since the images of the reference pattern and the measurement target are acquired separately, it is possible to perform image measurement with the same quality as that of conventional methods.

In addition, unlike the first embodiment, since the stage 110 and the reference pattern display unit 121 are integrally configured, the light path to the image capturing unit 141 is common to the measurement target W and the reference pattern. Therefore, compared to the image measuring apparatus 100 of the first embodiment, it is easier to ensure that the distortion in the image of the measurement target W is the identical with the distortion in the image of the reference pattern.

### Third Embodiment

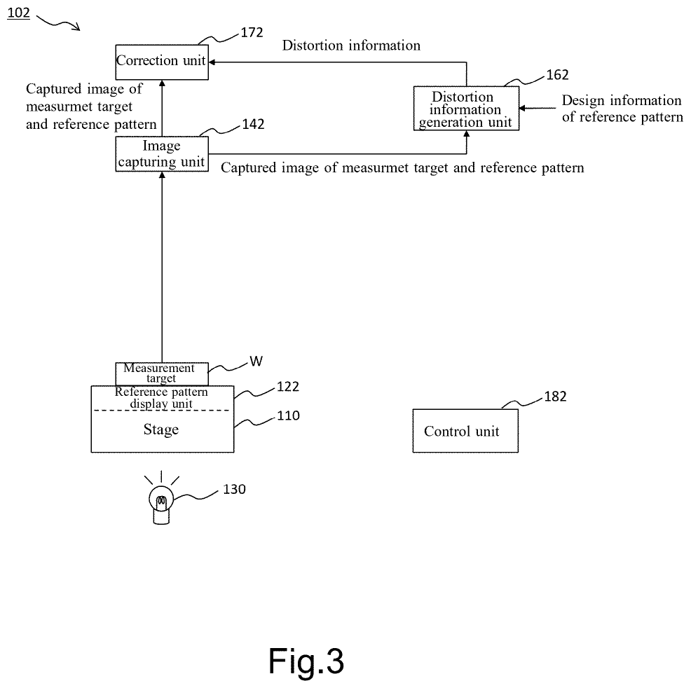

FIG. 3 shows the functional block diagram of the image measuring apparatus 102 according to the third embodiment. The image measuring apparatus 102 includes a stage 110, a reference pattern display unit 122, a light source 130, an image capturing unit 142, a distortion information generation unit 162, a correction unit 172, and a control unit 182.

On the mounting surface of stage 110, a reference pattern is formed, which serves as the reference pattern display 122. The reference may be formed by drawing directly on the mounting surface of the 110, or it may be formed by drawing on a surface of a substrate such as glass and then placing the substrate on the mounting surface of the stage 110. The term “drawing” here refers to the simple drawing of a reference pattern on a surface, as well as engraving or film deposition.

In this way, the stage 110 and the reference pattern display unit 122 are configured as a single unit, and the measurement target W is placed on the reference pattern.

The image capturing unit 142 is directed towards the stage 110 (reference pattern display unit 122) in order to capture images of the measurement target W and the drawn reference pattern.

The distortion information generation unit 162 generates distortion information based on the image containing the measurement target W and the reference pattern captured by the image capturing unit 142, and the design information of the reference pattern prepared in advance. Specifically, the dimensions of the reference pattern read from the image containing the measurement target W and the reference pattern are compared with the design dimensions and dimensional tolerances, and distortion information is generated based on the difference between them.

The correction unit 172 corrects the image containing the measurement target W and the reference pattern using the distortion information generated by the distortion information generation unit 162.

The control unit 182 performs control based on information input by the operator or based on a program that describes the processing flow and functions of each functional unit. The control unit 182 may be implemented by a personal computer that, for example, includes a CPU that executes a program to realize the described functions, various storage means that temporarily or permanently store programs and data, various input means such as keyboards and mice, various display means, and various communication means such as wired or wireless communication means.

Under the control of control unit 182, the correction process in the third embodiment is performed, for example, as follows.

When the operator places the measurement target W on stage 110 and issues a command to the control unit 182, the control unit 182 executes the correction process by controlling each functional unit according to the processing flow described in the program. Specifically, first, by causing the light source 130 to emit light, the image capturing unit 142 is caused to capture an image of the reference pattern together with the measurement target W. At this time, the captured image may be stored in a suitable storage means. Next, the distortion information generation unit 162 is caused to generate the distortion information based on the image containing the measurement target W and the reference pattern, and the design information of the reference pattern that has been prepared in advance. Then, the correction unit 172 is caused to correct the image containing the measurement target W and the reference pattern using the distortion information generated by the distortion information generation unit 162. The image that has been corrected in this way is then used in the image measurement process.

According to the image measuring apparatus 102 of the present invention described above, since the reference pattern is built in, there is no need to place the reference pattern on the stage when acquiring distortion information. Therefore, when acquiring distortion information during measurement, there is no need to replace the reference pattern on the stage with the measurement target. Therefore, the reference pattern can be automatically captured and distortion information can be generated at any arbitrary timing, for example, immediately before or during the execution of image measurement. As a result, the effort required to obtain distortion information is reduced, and it is possible to perform distortion correction flexibly in response to environmental changes.

Unlike the first and second embodiments, the image used to generate the distortion information and the image to which the correction is finally applied include the image of the reference pattern, but since the image can be captured in a single shot, image measurement can be performed in the same amount of time and with the same image data size as those of the conventional method.

In addition, the image measuring apparatus of the third embodiment can be realized at low cost by simply drawing the reference pattern on the stage 110.

### Fourth Embodiment

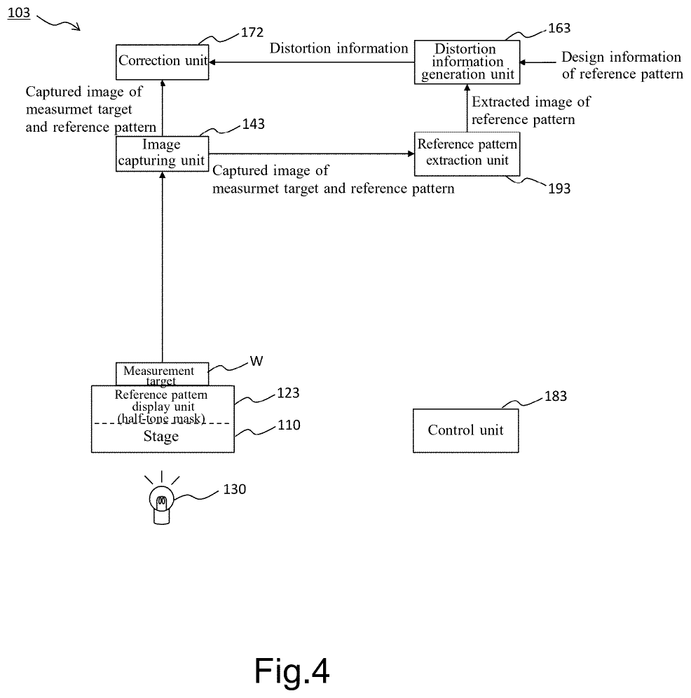

FIG. 4 shows the functional block diagram of the image measuring apparatus 103 according to the fourth embodiment. The image measuring apparatus 103 includes a stage 110, a reference pattern display unit 123, a light source 130, an image capturing unit 143, a reference pattern extraction unit 193, a distortion information generation unit 163, a correction unit 172, and a control unit 183.

On the mounting surface of stage 110, a reference pattern is formed with a half-tone mask, which serves as the reference pattern display 123. The reference pattern using the half-tone mask may be formed by directly depositing it on the mounting surface of the stage 110, or it may be formed by depositing it on a surface of a substrate such as glass and then placing the substrate on the mounting surface of the stage 110.

In this way, the stage 110 and the reference pattern display unit 123 are configured as a single unit, and the measurement target W is placed on the reference pattern.

The image capturing unit 143 is directed towards the stage 110 (reference pattern display unit 123) in order to capture images of the measurement target W and the reference pattern formed by the half-tone mask.

The reference pattern extraction unit 193 extracts the image of the reference pattern from the image containing the reference pattern formed with the half-tone mask and the measurement target W captured by the image capturing unit, based on the brightness value corresponding to the half-tone mask, for example.

Next, the distortion information generation unit 163 generates the distortion information based on the image of the reference pattern extracted by the reference pattern extraction unit and the design information of the reference pattern that has been prepared in advance. Specifically, the dimensions of the reference pattern read from the image of the reference pattern are compared with the design dimensions and dimensional tolerances, and distortion information is generated based on the difference between them.

The correction unit 172 corrects the image containing the measurement target W and the reference pattern formed with the half-tone mask using the distortion information generated by the distortion information generation unit 163.

The control unit 183 performs control based on information input by the operator or based on a program that describes the processing flow and functions of each functional unit. The control unit 183 may be implemented by a personal computer that, for example, includes a CPU that executes a program to realize the described functions, various storage means that temporarily or permanently store programs and data, various input means such as keyboards and mice, various display means, and various communication means such as wired or wireless communication means.

Under the control of control unit 183, the correction process in the fourth embodiment is performed, for example, as follows.

When the operator places the measurement target W on stage 110 and issues a command to the control unit 183, the control unit 183 executes the correction process by controlling each functional unit according to the processing flow described in the program. Specifically, first, by causing the light source 130 to emit light, the image capturing unit 143 is caused to capture an image of the reference pattern formed with the half-tone mask together with the measurement target W. At this time, the captured image may be stored in a suitable storage means. Next, the reference pattern extraction unit 193 is caused to extract the image of the reference pattern from the image containing the reference pattern formed with the half-tone mask together with the measurement target W. Next, the distortion information generation unit 163 is caused to generate the distortion information based on the image of the reference pattern extracted by the reference pattern extraction unit 193 and the design information of the reference pattern that has been prepared in advance. Then, the correction unit 172 is caused to correct the image containing the measurement target W and the reference pattern formed with the half-tone mask using the distortion information generated by the distortion information generation unit 163. The image that has been corrected in this way is then used in the image measurement process.

According to the image measuring apparatus 103 of the present invention described above, since the reference pattern is built in, there is no need to place the reference pattern on the stage when acquiring distortion information. Therefore, when acquiring distortion information during measurement, there is no need to replace the reference pattern on the stage with the measurement target. Therefore, the reference pattern can be automatically captured and distortion information can be generated at any arbitrary timing, for example, immediately before or during the execution of image measurement. As a result, the effort required to obtain distortion information is reduced, and it is possible to perform distortion correction flexibly in response to environmental changes.

Unlike the first and second embodiments, the image to which the correction is finally applied includes the image of the reference pattern, but since the image can be captured in a single shot, image measurement can be performed in the same amount of time and with the same image data size as those of the conventional method.

In addition, unlike the third embodiment, the image measuring apparatus of the fourth embodiment can improve the accuracy of distortion correction since it extracts the image of the reference pattern from the captured image and then generates distortion information based on the extracted reference pattern.

The present invention is not limited to the above embodiments. The above-mentioned embodiment is an example, and any configuration substantially the same as the technical idea described in the claims of the present invention and producing similar effects is included in the technical scope of the present invention, even if components are added, deleted, or modified. In other words, changes can be made as appropriate within the scope of the technical ideas expressed in the present invention, and forms with such changes and improvements are also included in the technical scope of the present invention.

With respect to the embodiments including the above examples, the following appendixes are further disclosed.

### Appendix 1

An image measuring apparatus comprising: a stage on which a measurement target is placed;
a reference pattern display unit on which a reference pattern is displayed;
an image capturing unit that captures images of a subject;
a distortion information generation unit that generates distortion information based on an image of the reference pattern captured by the image capturing unit and design information of the reference pattern; and
a correction unit that corrects an image of the measurement target captured by the image capturing unit using the distortion information.

### Appendix 2

The image measuring apparatus according to appendix 1, further comprising a subject switching unit that switches the subject to be captured by the image capturing unit between the measurement target and the reference pattern.

### Appendix 3

The image measuring apparatus according to Appendix 2, wherein the subject switching unit comprises:
a beam splitter that emits incident light from the measurement target and incident light from the reference pattern display unit toward the image capturing unit; and
Shutters that are provided between the measurement target and the beam splitter, and between the reference pattern display unit and the beam splitter, respectively, and
by opening and closing the respective shutters, the subject to be captured by the image capturing unit is switched.

### Appendix 4

The image measuring apparatus according to Appendix 1, wherein the stage is integrally configured with the reference pattern display unit by forming the reference pattern with a color filter mask on a mounting surface on which the measurement target is placed, and
the image measuring apparatus comprises a first light source that emits light of wavelengths that do not transmit through the color filter mask and a second light source that emits light of wavelengths that transmit through the color filter mask, and
wherein the distortion information generation unit generates distortion information based on the image containing the measurement target and the reference pattern captured by the image capturing unit when only the first light source is emitting light and the image containing the measurement target but lacking the reference pattern captured by the image capturing unit when only the second light source is emitting light, and the design information of the reference pattern, and
the correction unit corrects the image containing the measurement target but lacking the reference pattern using the distortion information.

### Appendix 5

The image measuring apparatus according to Appendix 1, wherein the stage is integrally configured with the reference pattern display unit by forming the reference pattern on a mounting surface on which the measurement target is placed,
the distortion information generation unit generates distortion information based on the image containing the measurement target and the reference pattern captured by the image capturing unit, and the design information of the reference pattern, and
the correction unit corrects the image containing the measurement target and the reference pattern using the distortion information.

### Appendix 6

The image measuring apparatus according to Appendix 1, wherein the stage is integrally configured with the reference pattern display unit by forming the reference pattern with a half-tone mask on a mounting surface on which the measurement target is placed, and
the image measuring apparatus further comprises a reference pattern extraction unit that extracts the image of the reference pattern from the image containing the measurement target and the reference pattern formed with the half-tone mask captured by the image capturing unit, and
wherein the distortion information generation unit generates the distortion information based on the image of the reference pattern extracted by the reference pattern extraction unit and the design information of the reference pattern, and
the correction unit corrects the image containing the measurement target and the reference pattern formed with the half-tone mask using the distortion information.

### Appendix 7

Non-transitory recording medium recording a program for causing a computer to function as the image measuring apparatus as described in any one of appendixes 1 to 6.

What is claimed is:

1. An image measuring apparatus comprising:
a stage on which a measurement target is placed;
a reference pattern display unit on which a reference pattern is displayed;
an image capturing unit that captures images of a subject;
a distortion information generation unit that generates distortion information based on an image of the reference pattern captured by the image capturing unit and design information of the reference pattern; and
a correction unit that corrects an image of the measurement target captured by the image capturing unit using the distortion information.

2. The image measuring apparatus according to claim 1, further comprising a subject switching unit that switches the subject to be captured by the image capturing unit between the measurement target and the reference pattern.

3. The image measuring apparatus according to claim 2, wherein the subject switching unit comprises:
a beam splitter that emits incident light from the measurement target and incident light from the reference pattern display unit toward the image capturing unit; and
Shutters that are provided between the measurement target and the beam splitter, and between the reference pattern display unit and the beam splitter, respectively, and
by opening and closing the respective shutters, the subject to be captured by the image capturing unit is switched.

4. The image measuring apparatus according to claim 1, wherein the stage is integrally configured with the reference pattern display unit by forming the reference pattern with a color filter mask on a mounting surface on which the measurement target is placed, and
the image measuring apparatus comprises a first light source that emits light of wavelengths that do not transmit through the color filter mask and a second light source that emits light of wavelengths that transmit through the color filter mask, and
wherein the distortion information generation unit generates distortion information based on the image containing the measurement target and the reference pattern captured by the image capturing unit when only the first light source is emitting light and the image containing the measurement target but lacking the reference pattern captured by the image capturing unit when only the second light source is emitting light, and the design information of the reference pattern, and
the correction unit corrects the image containing the measurement target but lacking the reference pattern using the distortion information.

5. The image measuring apparatus according to claim 1, wherein the stage is integrally configured with the reference pattern display unit by forming the reference pattern on a mounting surface on which the measurement target is placed,
the distortion information generation unit generates distortion information based on the image containing the measurement target and the reference pattern captured by the image capturing unit, and the design information of the reference pattern, and
the correction unit corrects the image containing the measurement target and the reference pattern using the distortion information.

6. The image measuring apparatus according to claim 1, wherein the stage is integrally configured with the reference pattern display unit by forming the reference pattern with a half-tone mask on a mounting surface on which the measurement target is placed,
the image measuring apparatus further comprises a reference pattern extraction unit that extracts the image of the reference pattern from the image containing the measurement target and the reference pattern formed with the half-tone mask captured by the image capturing unit, and
wherein the distortion information generation unit generates the distortion information based on the image of the reference pattern extracted by the reference pattern extraction unit and the design information of the reference pattern, and
the correction unit corrects the image containing the measurement target and the reference pattern formed with the half-tone mask using the distortion information.

7. A non-transitory recording medium recording a program for causing a computer to function as the image measuring apparatus according to claim 1.
